(19) United States
(12) Patent Application Publication
(10) Pub. No.: US 2021/0295615 A1
(43) Pub. Date: Sep. 23, 2021

(54) ELECTRIC VEHICLE ENERGY BALANCE CREDITING AND DEBITING SYSTEM AND A METHOD THEREOF

(71) Applicant: Elaphe Pogonske Tehnologije D.o.o., Ljubljana (SI)

(72) Inventors: Gorazd Gotovac, Ljubljana (SI); Ziga Povalej, Kamnik (SI)

(73) Assignee: Elaphe Pogonske Tehnologije D. o.o., Ljubljana (SI)

(21) Appl. No.: 17/257,603

(22) PCT Filed: Jul. 3, 2018
(86) PCT No.: PCT/SI2018/000018

§ 371 Date: Jan. 4, 2021

(51) Int. Cl. G07C 5/08; G07C 5/00; B60L 53/14; B60L 53/66; G06Q 30/06; G06Q 30/02

(52) U.S. Cl. CPC G07C 5/085; G07C 5/008; G06Q 30/0283; B60L 53/665; G06Q 30/0645; B60L 53/14

(57) ABSTRACT

The system for a secure and verifiable measurement and data logging of electric vehicle energy balance, wherein vehicle energy balance status supervision provides basis for pre-payment accounting, energy charging allowances, excise taxation, and infrastructure investment payback schemes using predetermined intervals and micro-payment transactions using smart contracts. The system comprises a measurement and data logging device onboard a vehicle, and a decentralized and cryptographically safe database, using a method of transferring blockchain encoded multi-leveled information based on said logged data for mathematical algorithms to calculate and autonomously execute contract fund transactions like excise tax, car rental service payment, vehicle roaming, and grant greater supervision and control over fleet management and vehicle manufacturer warranty limits for example.

### TECHNICAL FIELD

The invention relates to a system and a method for use in electric vehicles, covering generation and usage of electric vehicle energy balance data for execution of cryptographic crediting and debiting smart contracts, taking into account various charging and discharging events registered by vehicle, and thus creating accurate basis for pre-payment accounting, excise taxation, and infrastructure investment payback schemes.

### BACKGROUND ART

States around the globe are already registering fall of revenues from fuel duty (excise duty), due to gradual transition to plug-in hybrid and all-electric vehicles, thus they are on a mission to fill the treasury gap. While there are suggestions to apply a direct per-unit tax at the time of sale, just like with the system used on petrol and diesel fuel, one can notice major differences which make this solution inadequate. Electric energy, being much more accessible than fossil fuel, offers multiple types of charging sources for the electric vehicle. If public charging stations were the only points for energy transfer to a vehicle, above mentioned suggestion to a solution would be plausible. But in reality, most of the electric vehicles are charged by household grid during the night, which at the moment means that not only there are no transport revenues for the state collected, but also the price for transferred energy is equal to the household one, making an electric vehicle part of the home appliances category. Furthermore, if electric vehicle is charged with electricity from household renewable sources, like solar panels or wind power generator for example, then state energy regulation reach becomes significantly limited. Solutions such as registration flat-rate fee based on fossil fuel vehicle driving statistic, or duty based on monitoring vehicle periodical mileage, should be considered as highly inaccurate, and in certain cases privacy intrusive, unable to offer flexibility in many different aspects that modern technology brings along.

One such modern technology being so called “vehicle to grid” (V2G) system where surplus of electric energy contained within electric vehicles not in use (parked and connected to charging station), could be transferred to help the electric grid to overcome peak loads and thus vehicle owner could receive back certain benefits from the grid, or even direct fund or tax compensation. Major technological advancement achieved in the increase of electric energy storage capacity, has further expanded possible ways of using the stored energy within an electric vehicle. For example, “vehicle to home” (V2H) or “vehicle to building” (V2B) system where electric energy stored in vehicle battery could also be used to power household appliances for a certain period of time, or even help regulate electric grid where and while vehicle owner is at work. Even a concept of charging between vehicles is contemplated and most probably necessary in the situation where for example vehicle with an empty battery would need just enough power to reach nearest charging point and other options of recharging were not available.

While most of the prior art is focused on direct billing and sometimes taxation of accomplished charging of an electric vehicle, it is clear that flexible and broader spectrum of electric power manipulation control is necessary. Many of the solutions include power metering devices mounted solely on the charging stations which perform metering only locally and for the needs of charging station owner, usually electricity distributor. This way the dynamics of energy transfer and the energy consumption of the vehicle itself, which should be main basis for taxation, become overlooked data, which should otherwise be of great use for the electric smart grid planning and a primary input for state ecology and energy long-term strategies. Undoubtedly there is non-negligible difference in the amount of the electric energy given by charging station and the same received by electric vehicle, mainly because of AC/DC conversion losses. This phenomenon should be monitored and analysed and set as a foundation for further technological improvement in this area for a greater control of power distribution. For achieving above mentioned goal, a power meter mounted on-board vehicle is preferred, which has already been recognized by prior art.

The solutions proposed in U.S. Pat. No. 9,505,317B2 and US20100241560A1 for example, cover usual communication between electric vehicle and charging station, where after each charging event, a “energy transfer for fund” compensation is executed, and approval of whole process to be performed is based on fund status of the vehicle owner account. Focus of these solutions is relatively narrow, taking into account only public charging station energy transfer event with power metering device mounted on charging station, no solution for taxation or alternative type charging sources is presented. US2010141203A1 and US20100145885A1 focus on an electric meter mounted on a vehicle which can recognize different charging sources, also covers “e-grid” billing structure and offers vehicle energy consumption data for easier electric grid peak load regulation. This offers a contribution to the connectivity and usability of the smart grid, however, it lacks a solution, which would offer leverage for state excise taxation and does not cover situation where electric vehicle is discharging into smart grid and needs to be refunded for it in some way or another. The main obstacle for achieving this seems to be a communication only on a consumer-provider level.

As we can learn from the prior art, there were no major changes in the concept of selling electric energy. Established principles of trade seem to stick to the old patterns and fail to adapt fast enough to a rapid evolving technology, which increasingly requires decentralisation, flexibility and customization towards customer. While we can see the introduction of some new methods of payment for the received energy and faster means for the communication, the rigid concept of consumer-provider relationship persists, which is somewhat limiting if we want to integrate state or global energy strategies and regulations. Also, it seems that solutions in prior art only focus on the scheme where electric energy flows in direction from supplier to customer and funds flow from customer to supplier.

As far as the communication between electric energy source and electric vehicle in the prior art, we can learn that there exists a certain level of secure information exchange, which on a basic level can contribute to successful fund transactions and even other services like taxation, which can be seen in U.S. Pat. No. 8,754,743B2. However, communication and authorisation of the exchanged data in this way is ever more prone to security breaches and data manipulations, either from the third party or even directly involved parties, since IT field evolves at tremendous pace and is accessible to a wide range of population. Taxation process mentioned in this patent, where customer has to wait for the taxation to complete (engine even being prevented to start), explicitly shows how time consuming and awkward services can become if one relies on outdated systems.

A blockchain is a decentralized, distributed and public digital ledger that is used to record transactions across many computers so that the record cannot be altered retroactively without the alteration of all subsequent blocks and the collusion of the network. A blockchain database is managed autonomously using a peer-to-peer network and a distributed timestamping server. They are authenticated by mass collaboration powered by collective self-interests. The use of a blockchain removes the characteristic of infinite reproducibility from a digital asset. It confirms that each unit of value was transferred only once, solving the long-standing problem of double spending. A blockchain can assign title rights because it provides a record that compels offer and acceptance. Blocks hold batches of valid transactions that are hashed and encoded. Each block includes the cryptographic hash of the prior block in the blockchain, linking the two. The linked blocks form a chain. This iterative process confirms the integrity of the previous block, all the way back to the original genesis block. By storing data across its network, the blockchain eliminates the risks that come with data being held centrally. The decentralized blockchain may use ad-hoc message passing and distributed networking. Its network lacks centralized points of vulnerability that computer crackers can exploit; likewise, it has no central point of failure. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or the means to otherwise interact with the various capabilities that blockchains support.

A smart contract is a computer protocol intended to digitally facilitate, verify, or enforce the negotiation or performance of a contract. Smart contracts allow the performance of credible transactions without third parties. These transactions are trackable and irreversible. The aim of smart contracts is to provide security that is superior to traditional contract law and to reduce other transaction costs associated with contracting. Blockchain-based smart contracts are contracts that can be partially or fully executed or enforced without human interaction. One of the main objectives of a smart contract is automated escrow. Some blockchain implementations could enable the coding of contracts that will execute when specified conditions are met. A blockchain smart contract would be enabled by extensible programming instructions that define and execute an agreement.

### SUMMARY OF THE INVENTION

Problems and challenges described above are solved with the system for a secure and verifiable measurement and data logging of electric vehicle energy balance, where vehicle energy balance status supervision provides basis for pre-payment accounting, energy charging allowances, excise taxation, and infrastructure investment payback schemes using algorithm defined time intervals and micro-payment transactions using smart contracts.

This system comprises a measurement and data logging device on-board a vehicle. It also comprises a decentralized and cryptographically secure database. The database is using blockchain encoded multi-level information based on said logged data for mathematical algorithms to calculate and autonomously execute contract fund transactions. For example excise tax, car rental service payment, vehicle roaming. It can also grant greater supervision and control over fleet management and vehicle manufacturer warranty limits for example. An upgrade to a concept of a smart grid system which comprises immense dynamics of the number and type of events in comparison to common electric grid system and thus cannot tolerate linear and flat regulations of operation. System is adaptable to various electricity price regulations like time and location dependent price variations, charging source type specifics (public charging stations, household grid, private renewable energy sources, fast charging infrastructure etc.) and is able to manage both charging and discharging events where crediting and debiting can occur autonomously in multiple directions between multiple parties, either for the purpose of energy transfer or for implementation of various state regulated duties. The proposed Electric vehicle energy balance crediting and debiting system and a method thereof allows for a fair distribution of excise taxations between private and public providers of infrastructure, including individuals providing renewable sources of energy for their own use, allowing a better platform for electric vehicle infrastructure expansion and at the same time greatly reducing the impact of the electric vehicle volumes on the household and industry rates for electricity.

A brief description of the drawings;

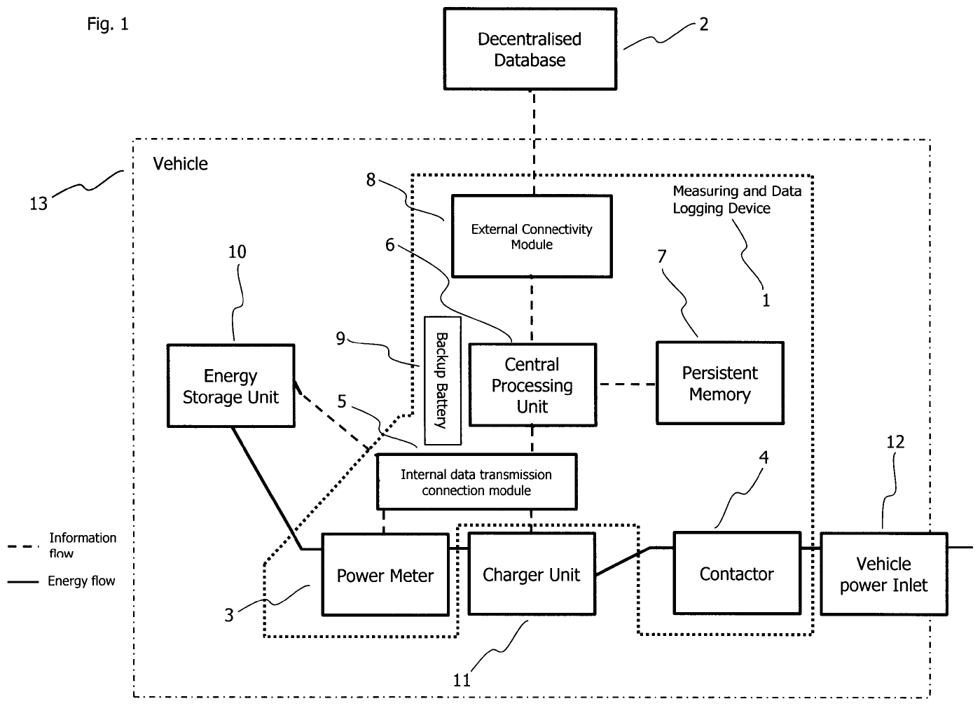

FIG. 1 is a diagrammatic representation of measurement and data logging system;

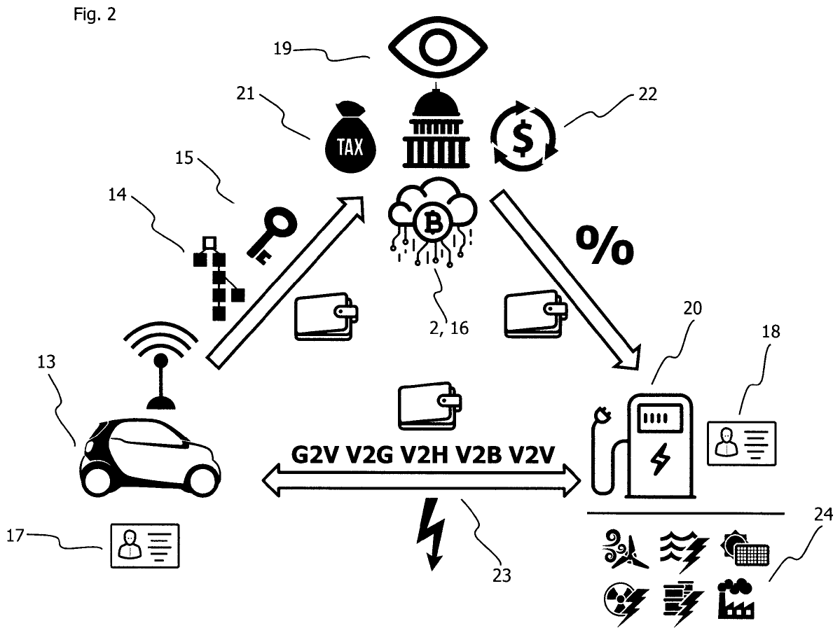

FIG. 2 is a diagrammatic representation of method for vehicle energy balance data generation and transfer thereof;

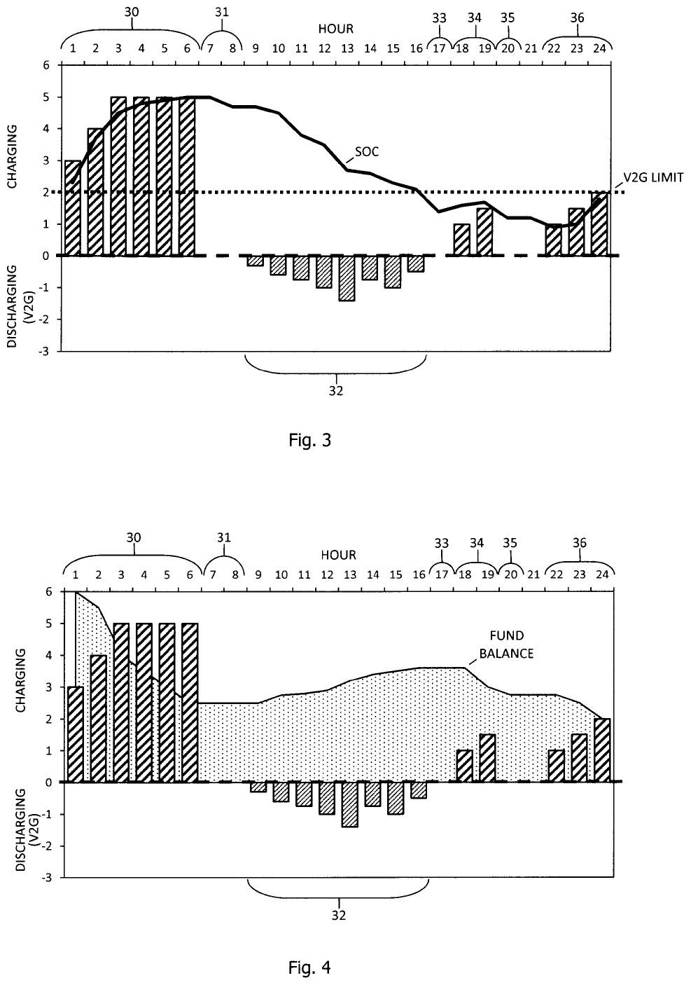

FIG. 3 is a chart representation of electric vehicle energy balance dynamics during 24 hours with influence on SOC balance;

FIG. 4 is a chart representation of electric vehicle energy balance dynamics during 24 hours with influence on fund balance.

Identical or corresponding elements have the same reference signs throughout the description.

### DETAILED DESCRIPTION OF THE INVENTION

Electric vehicle energy balance crediting and debiting system and a method thereof use a energy balance data of an electric vehicle as a basis for running all of the activities necessary for a fair, accurate and transparent processing of energy transfer events and their financial aspect. Rather than dealing with each and every charging or discharging event individually, a energy balance system measures and logs all events into a secure and verifiable distributed ledger at each time determined by the predefined algorithm and consequently tracks the vehicle owner credit status in real time. Therefore, taxation for example can occur at the end of each predetermined interval by taking into account all of the energy flow within that interval, varying energy prices depending on the different charging sources, time and location of energy transfer and so on. It is mainly intended for use with pre-paid system but can be easily implemented also with other billing systems. Gist of the invention is a solution for fast, secure and transparent implementation of excise type transactions between electric vehicle owner and state or state certified entity or an infrastructure provider based on overall vehicle energy balance, where individual events of direct energy and fund transfer (23) between vehicle owner and electricity distributor are left to be dealt on a level already known by prior art. In fact, this solution gives ground for implementation of various types of infrastructure investment payback schemes (22) between state (19) and electric energy producer and/or supplier (20), and also giving a wide range of possibilities for encouraging or limiting different energy generating technologies (24).

The present invention comprises a combination of a data logging device, a secure and verifiable database. The said data logging device comprising secure power measuring module capable of reliably and accurately measuring magnitude and direction of energy flow between the vehicle power inlet and the on board charger or between the vehicle inlet and the battery in case of DC charging. The said data logging device having implemented protection mechanisms for protecting against device manipulation. In addition also containing a disconnecting module, such as a contactor, capable of interrupting the connection of all power inlets to the battery in case the credit limit has been reached. Moreover the said data logging device having a secure wired connection to other devices in the vehicle. A part of the said data logging device is also a CPU with reliable persistent memory. Additionally the device containing connectivity module, allowing secure connection to the internet and sending the information to the secure and verifiable database. The said secure and verifiable database, being the second integral part of the invention, whereas the blockchain technology or a similar distributed ledger technology is used to guarantee that the information cannot be counterfeited. The secure and verifiable database is therefore providing grounds for automatic transaction execution with the use of smart contracts or similar technologies.

Preferred embodiment of the measurement and data logging system comprises of a measuring and data logging device (1), and a database (2). The measuring and data logging device further comprises power meter (3), a contactor (4), an internal data transmission connection module (5), a central processing unit (6) with memory unit (7), and a connectivity module (8) allowing connection to the internet. Said device is designed in such a way that it cannot be altered wholly or partially without causing either a visual change or/and a secure and verifiable log in the cryptographically secure database (2). This device has a backup battery (9) unit allowing uninterrupted measurement and communication with the database, even if it is disconnected from the energy storage unit (10). A power meter (3) is capable of reliably and accurately measuring magnitude and direction of energy flow on the DC line between the external DC charger unit (11) and the vehicle energy storage unit (10). A power meter (3) is capable of measuring the power on the AC line between the vehicle power inlet (12) or the vehicle induction charging receiver (not shown) and the on-board charger unit (11). A contactor (4) is intended for reliable switching off the connection between the vehicle power inlet (12) and the on-board charger unit (11), in case the user credit limit is reached or in other cases where the terms do not allow further charging of the vehicle. This measuring and data logging device (1) can be partially or wholly integrated with one or more other devices in the vehicle (13), therefore an internal data transmission connection module (5), which can be either an Ethernet, CAN, flexray, bluetooth or other data transmission connection, is needed. The measurement and data logging system as mentioned contains a decentralized and cryptographically secure database (2), which allows specific data access to mathematical algorithms. The decentralized and cryptographically secure database is based on cloud and blockchain technology, and mathematical algorithms using the data are so called smart contracts or can be other algorithms operating on a similar principle. Mathematical algorithms securely and authentically calculate the parameters and execute transactions according to pre-agreed terms, and also allow the measuring and data logging device (1) to access and write encoded data into the database (2). For this to happen, a matching private security key combination should be provided by the measuring and data logging device (1).

The method presented here is closely involved with above mentioned cryptographic technology and uses it as a means for executing several of its steps needed for this solution. In detail a method for vehicle energy balance data generation and transfer thereof comprises of:
real-time vehicle energy balance data generation by a measuring and data logging device (1) on-board a vehicle (13—FIG. 2);
cryptographic coding of said data generated by the measuring and data logging device (1) on-board the vehicle;
transferring of said coded data (14) to a decentralized and cryptographically secure database (2) at points in time defined by a predetermined algorithm;
checking said device private security key (15) adequacy by said database (2);
logging of said coded data into the said database;
accessing said logged coded data by mathematical algorithms (16) through a public or private key, said mathematical algorithms calculation execution based on said logged data (14);
execution of transactions based on the said mathematical algorithms outcomes.

A real-time vehicle energy balance data generation means that multi-level information, including vehicle identification (17), energy source identification (18) when charging or discharging, transferred energy quantity, and energy transfer time and location is generated while not excluding other possible information. Generated data cryptographic coding is based on blockchain technology, same being true also for decentralized and cryptographically secure database (2) that runs on cloud computing platform. Above mentioned mathematical algorithms (16) are so called smart contracts, or algorithms operating on a similar principle. One or more smart contracts is implemented between the measuring and data logging device and one or more other parties, including but not limited to the state (19) and infrastructure, and electricity providers (20). The smart contracts execute fund transfers between the contractual parties based on the energy transfer data logged in the decentralized and cryptographically secure database (2). Actually, an implementation of several smart contracts is possible, like excise tax contract (21), car rental service, fleet management, vehicle roaming, and vehicle manufacturer warranty limits contract for example, while not excluding some other possible contracts. These smart contracts have independent security keys for access to parts of the blockchain relevant to their specific transactions.

A possible embodiment of the method is presented by the following sequence of events within a period of 24 hours: The first step being overnight household grid charging (30) of the electric vehicle battery to a full capacity. This first step accomplished would cause a positive energy flow to the vehicle, an increase of State of Charge (SOC) and fall of funds level, calculated by the amount of transferred energy and other recorded information such as the time of day, type of power outlet (“residential grid” or “privately owned solar powered grid”), etc. Next event would be a transportation to a work place (31) where a certain amount of energy would be consumed, SOC level falls, but funds level is unchanged, since there was no energy flow between the vehicle power inlet and on-board charger. Parked and inactive vehicle would then be able to participate a certain amount of its stored energy (32) into public or building electricity grid to help level out peak loads etc. Amount of available energy for V2G transfer is limited and set by electric vehicle owner in accordance with his daily plan of travel and vehicle smart energy balance system recommendations. This event would cause a negative energy flow from the vehicle, SOC level to fall and funds level to rise in accordance with a grid refund based on transferred energy quantity and other information such as time of day, location, etc. Following event would be a transport to a grocery store (33) on the way home, where again, some energy would be consumed and SOC level decreased, but without change of funds. Next event would include rapid charging by grocery store parking charging station (34) in the time needed for shopping, leading to positive energy flow to the vehicle, SOC level increase and funds level decrease, based on the amount of energy and the location of charging station. Infrastructure providers, such as the grocery store in this scenario, may give discounts or extra charges based on the location and type of charging infrastructure. The rest of the trip home (35) would result in another SOC decrease without change of balance, and the last event of the day—household grid charging until next morning (36). In case of a household grid interruption (electric grid maintenance for example), vehicle could, for a period of time, be used as a backup energy source for the household appliances, resulting with an increase of energy balance to the owner for providing the grid backup service. Vehicle owner would periodically or continuously have to balance his/her funds to maintain ability to use the vehicle in similar to described manner. Scenario described tries to include as much diversity of events as possible, to show the complexity and dynamics that need to be considered, and this system and method provide solution for, but does not exclude different kinds of scenarios.

1. A secure and verifiable measurement and data logging system comprising:
a measuring and data logging device onboard a vehicle, wherein said measuring and data logging device comprises
a power meter adapted for measuring magnitude and direction of an energy flow between a vehicle power inlet and a energy storage unit,
a data transmission connection to at least one additional device in the vehicle,
a central processing unit having a persistent memory unit,
a connectivity module in connection to the internet; and
a decentralized and cryptographically secured database, and
wherein said database allows a specific data access to mathematical algorithms executing pre-agreed transactions and allowing said measuring and data logging device to access and write encoded data into said database, when a matching security key is provided by the said device and having capability of reliably preventing charging of the on-board energy storage.

2. The secure and verifiable measurement and data logging system according to claim 1, including a charging prevention capable of reliably disconnecting the connection between the vehicle power inlet and the on-board charger unit or the energy storage unit.

3. The secure and verifiable measurement and data logging system according to claim 1, wherein said measuring and data logging device cannot be substantially altered without causing either a visual change or/and a secure and verifiable log in the cryptographically secure database.

4. The secure and verifiable measurement and data logging system according to claim 1, wherein said measuring and data logging device is substantially integrated with one or more other devices in the vehicle.

5. The secure and verifiable measurement and data logging system according to claim 1, wherein said measuring and data logging device comprises a backup battery unit adapted for uninterrupted measurement and communication with the database when disconnected from the power supply.

6. The secure and verifiable measurement and data logging system according to claim 1, wherein said decentralized and cryptographically secure database comprises cloud and blockchain technology based.

7. The secure and verifiable measurement and data logging system according to claim 1, wherein the mathematical algorithms comprise smart contracts.

8. The secure and verifiable measurement and data logging system according to claim 1, wherein the power is measured on an AC line between the vehicle power inlet or the vehicle induction charging receiver and the on-board charger.

9. A method for vehicle energy balance data generation and transfer thereof, said method comprising:
generating a real-time vehicle energy balance data by measuring and data logging onboard a vehicle;
cryptographic coding of said data generated by the measuring and data logging device onboard the vehicle;
transferring of said coded data to a decentralized and cryptographically secure database at points in time defined by a predetermined algorithm;
logging of said coded data into the said database;
accessing said logged coded data by mathematical algorithms, wherein said mathematical algorithms calculation execution based on said logged data; and
executing transactions based on the said mathematical algorithms outcomes.

10. The method for vehicle energy balance data generation and transfer thereof according to claim 9, wherein said real-time vehicle energy balance data generation comprises a multi-level information.

11. The method for vehicle energy balance data generation and transfer thereof according to claim 9, wherein the cryptographic coding of the data generated includes blockchain technology.

12. The method for vehicle energy balance data generation and transfer thereof according to claim 9, wherein the decentralized and the cryptographically secure database includes cloud and blockchain technology based.

13. The method for vehicle energy balance data generation and transfer thereof according to claim 9, wherein the mathematical algorithms being smart contracts.

14. The method for vehicle energy balance data generation and transfer thereof according to claim 9, including implementing one or more smart contracts between said measuring and data logging device comprises government and infrastructure providers.

15. The method for vehicle energy balance data generation and transfer thereof according to claim 9, wherein implementing smart contracts comprises implementing excise tax contract, car rental service contract, fleet management contract, vehicle roaming contract, and vehicle manufacturer warranty limits contract.

16. The method for vehicle energy balance data generation and transfer thereof according to claim 9, wherein said smart contracts comprise a plurality of independent keys to access information in the blockchain relevant to their specific transactions.

17. The method for vehicle energy balance data generation and transfer thereof according to claim 9, wherein the vehicle energy balance status supervision provides a basis for pre-payment accounting, energy charging allowances, excise taxation, and infrastructure investment payback schemes using predetermined intervals and micro-payment transactions using smart contracts.

18. The method for vehicle energy balance data generation and transfer thereof according to claim 10, wherein said multi-level information includes a vehicle identification, a power source identification, a transferred energy quantity, an energy transfer time, an energy transfer time location.

19. The method for vehicle energy balance data generation and transfer thereof according to claim 14, wherein the smart contracts execute fund transfers between the contractual parties based on the energy transfer data logged in said decentralized and cryptographically secure database.

20. A method of vehicle energy balance data generation and transfer, said method comprising:
generating a real-time vehicle energy balance data having a multi-level information;
cryptographic coding of said data generated by the measuring and data logging device onboard the vehicle;
transferring said coded data to a decentralized and cryptographically secure database;
accessing a coded data; and
executing transactions based on at least one mathematical algorithms outcome.
